(19) United States
(12) Patent Application Publication
(10) Pub. No.: US 2026/0300378 A1
(43) Pub. Date: Oct. 1, 2026

(54) SYSTEM AND METHODS FOR HUMAN-INTERPRETABLE AUTONOMOUS SCENE SEARCH

(71) Applicant: AVRIDE Inc., Newburyport, MA (US)

(72) Inventors: Ruslan Burakov, Tel Aviv (IL); Mikhail Erofeev, Austin, TX (US); Nikolai Shcheglov, Austin, TX (US); Andrey Rykov, Austin, TX (US)

(21) Appl. No.: 19/578,139

(22) Filed: Mar. 25, 2026

Related U.S. Application Data
(60) Provisional application No. 63/777,192, filed on Mar. 25, 2025.

(51) Int. Cl. G06F 16/53; G06V 20/40

(52) U.S. Cl. CPC G06F 16/53; G06V 20/41

(57) ABSTRACT

Provided herein is a system and method for human-interpretable autonomous scene search, the system including: at least one processor; a memory communicatively connected to the at least one processor, wherein the memory contains instructions configuring the at least one processor to: receive a plurality of frames of video data; preprocess the plurality of frames of video data, wherein preprocessing the plurality of frames of video data includes removing duplicative data from the plurality of frames of video data; generate a natural language scene description, using a primary large language model; save the natural language scene description to a scene search database; receive from a user, a user-defined query; and return one or more frames of video data selected from the plurality of frames of video data as a function of associated natural language scene descriptions for the plurality of frames of video data and the user-defined query.

### CROSS REFERENCE TO RELATED APPLICATIONS

This application claims the benefit of priority to U.S. Provisional Application 63/777,192, filed on Mar. 25, 2025, and entitled “SYSTEM AND METHOD FOR HUMAN-INTERPRETABLE AUTOMATIC SCENE SEARCH FOR AUTONOMOUS DRIVING SYSTEM DEVELOPMENT,” the entirety of which is incorporated herein by reference.

### FIELD OF THE INVENTION

The present invention is directed generally to image processing. In particular, the present invention is directed to systems and methods for human-interpretable autonomous scene search.

### BACKGROUND OF THE INVENTION

Systems used for automated scene analysis typically use single preprocessing techniques to provide results based on scene data for automatic scene searches. However, the systems employed historically fail to provide a combination of preprocessing techniques which provides a disadvantage in the efficiency and accuracy of scene data .

Therefore, the need exists for a system for automated analysis, annotation, and retrieval of scene data that enables efficient, accurate, and contextually rich searching of scene data based on natural language queries. Additionally, there exists a need for a scene searching tool that is able to filter or adjust natural language queries to refine them to include more relevant, searchable information.

The present invention solves problems experienced with the prior art because it provides a system for automated analysis, annotation, and retrieval of scene data that enables efficient, accurate, and contextually rich searching of scene data based on natural language queries. Those and other advantages and benefits of the present invention will become apparent from the detailed description of the invention hereinbelow.

Accordingly, there remains a need in the art for scene searching tool that improves upon existing methods for video processing and scene searching The present disclosure meets this need.

### SUMMARY

In some aspects, the techniques described herein relate to a system for human-interpretable autonomous scene search, the system including: at least one processor; a memory communicatively connected to the at least one processor, wherein the memory contains instructions configuring the at least one processor to: receive a plurality of frames of video data; preprocess the plurality of frames of video data, wherein preprocessing the plurality of frames of video data includes removing duplicative data from the plurality of frames of video data; generate a natural language scene description, using a primary large language model, wherein generating the natural language scene description includes: inputting the preprocessed plurality of frames of video data and a prompt into the primary large language model; and receiving, as output from the primary large language model, the natural language scene description; save the natural language scene description to a scene search database; receive from a user, a user-defined query; and return one or more frames of video data selected from the plurality of frames of video data as a function of associated natural language scene descriptions for the plurality of frames of video data and the user-defined query.

In some aspects, the techniques described herein relate to a method for human-interpretable autonomous scene search, the method including: preprocessing, using at least one processor, the plurality of frames of video data, wherein preprocessing the plurality of frames of video data includes removing duplicative data from the plurality of frames of video data; generating, using the at least processor, a natural language scene description, using a primary large language model, wherein generating the natural language scene description includes: inputting the preprocessed plurality of frames of video data and a prompt into the primary large language model; and receiving, as output from the primary large language model, the natural language scene description; saving, using the at least one processor, the natural language scene description to a scene search database; receiving, using the at least one processor, from a user, a user-defined query; and returning, using the at least one processor, one or more frames of video data selected from the plurality of frames of video data as a function of associated natural language scene descriptions for the plurality of frames of video data and the user-defined query.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary system for human-interpretable autonomous scene search;

FIG. 2 shows an exemplary embodiment of result user interface;

FIGS. 3A and 3B show an exemplary embodiment of a vehicle computing architecture;

FIG. 4 shows an exemplary embodiment of a machine-learning module;

FIG. 5 shows an exemplary embodiment of a neural network;

FIG. 6 shows a flow diagram of an exemplary embodiment of a method for human-interpretable autonomous scene search; and

FIG. 7 shows an exemplary embodiment of a computing device in the exemplary form of a computer system.

### DETAILED DESCRIPTION..

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

“Video data,” for the purposes of this disclosure, is data that represents a sequence of visual images, wherein the visual images are supposed to be displayed in sequence so as to create the illusion of motion.

A “frame” of video data, for the purposes of this disclosure, is a still image of the sequence of visual images making up a video.

For the purposes of this disclosure, an “autonomous vehicle” is a device that is capable of moving people or things from one point to another in a manner that relies primarily on computer algorithms to guide and control the vehicle.

A “natural language scene description,” for the purposes of this disclosure, is a description of the contents of a frame of a video or picture, wherein the description is written in natural language.

A “large language model,” or “LLM,” as used herein, is a deep learning data structure that can recognize, summarize, translate, predict and/or generate text and other content based on knowledge gained from massive datasets.

A “multi-modal large language model,” for the purposes of this disclosure, is a model comprising a large language model backbone, wherein the model is configured to take multiple data modalities as input and encode them for input into the large language model backbone.

A “user-defined query,” for the purposes of this disclosure, is a question or request that is composed by a user.

### DETAILED DESCRIPTION

The present invention is directed generally to a method and apparatus for automated analysis, annotation and retrieval of scene data and, may be directed more particularly to a system and method for human-interpretable automatic scene search for autonomous driving system development.

The present invention solves problems experienced with the prior art because it provides a system for automated analysis, annotation, and retrieval of scene data that enables efficient, accurate, and contextually rich searching of scene data based on natural language queries. Those and other advantages and benefits of the present invention will become apparent from the detailed description of the invention hereinbelow.

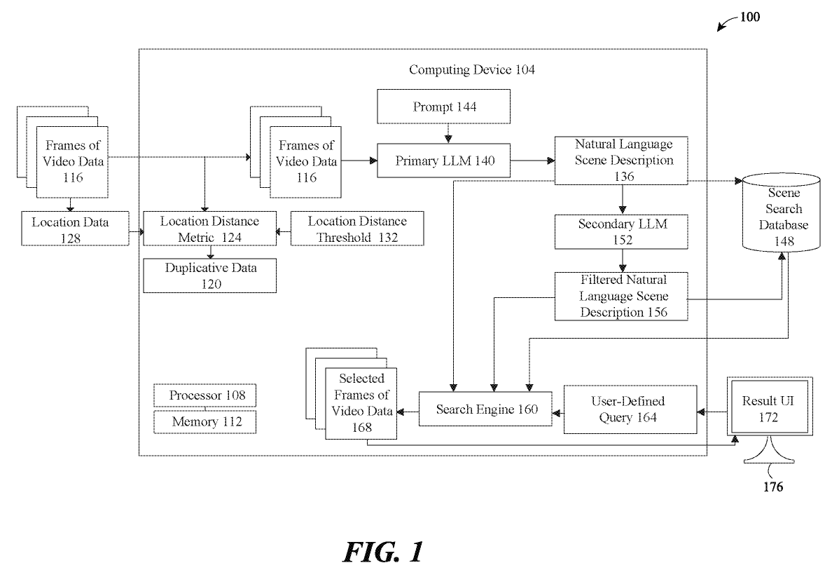

Referring now to FIG. 1, an exemplary system 100 for human-interpretable autonomous scene search is shown. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 includes at least one processor 108. Computing device 104 includes a memory 112. Memory 112 may include instructions configuring at least one processor 108 to perform one or more actions as described throughout this disclosure.

### Receiving Data

With continued reference to FIG. 1, memory 112 may include instructions configuring processor 108 to receive a plurality of frames of video data 116. frames of video data 116 may include data collected using one or more cameras. One or more cameras may include a plurality of cameras. In some cases, a camera may include one or more optics. Exemplary non-limiting optics include spherical lenses, aspherical lenses, reflectors, polarizers, filters, windows, aperture stops, and the like. In some embodiments, one or more optics associated with a camera may be adjusted in order to, in non-limiting examples, change the zoom, depth of field, and/or focus distance of the camera. In some embodiments, an autofocus mechanism may be used to determine focus distance. In some embodiments, at least a camera may include an image sensor. Exemplary non-limiting image sensors include digital image sensors, such as without limitation charge-coupled device (CCD) sensors and complimentary metal-oxide-semiconductor (CMOS) sensors. In some embodiments, a camera may be sensitive within a non-visible range of electromagnetic radiation, such as without limitation infrared. In some embodiments, a camera may include a video camera.

With continued reference to FIG. 1, cameras may be disposed at various positions around a roof of vehicle. In some embodiments, cameras may be disposed along a circumferential line on a roof of vehicle. Cameras may be evenly spaced apart. In some embodiment, cameras may be attached to a roof of a vehicle.

With continued reference to FIG. 1, frames of video data 116 may be collected using an autonomous vehicle or a non-autonomous vehicle. Autonomous vehicles, such as those equipped with LIDAR and/or camera sensors may gather data regarding the environments that they encounter. This may happen passively; i.e., autonomous vehicles may store data that they collect from environments as they go about their tasks.

With continued reference to FIG. 1, frames of video data 116 may be retrieved from a vehicle and/or autonomous vehicle. As a non-limiting example, the vehicle may be equipped with cameras and may collect data as it drives around. This data may be stored locally or streamed to computing device 104. In some embodiments, computing device 104 may retrieve the locally stored frames of video data 116. In some embodiments, frames of video data 116 may be stored in a database such as a video database. In some embodiments, the vehicle may send frames of video data 116 to video database once they have been collected. In some embodiments, the vehicle may locally store the frames of video data 116 the send them to video database; as a non-limiting example, this may occur when the vehicle detects a data connection or when the vehicle is not in use. Video database may be implemented, without limitation, as a relational database, a key-value retrieval database such as a NOSQL database, or any other format or structure for use as a database that a person skilled in the art would recognize as suitable upon review of the entirety of this disclosure. Video database may alternatively or additionally be implemented using a distributed data storage protocol and/or data structure, such as a distributed hash table or the like. Video database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

### Preprocessing Data

With continued reference to FIG. 1, memory 112 may include instructions configuring processor 108 to preprocess frames of video data 116. In some embodiments, frames of video data may include raw scene data, where raw scene data includes, as non-limiting examples, video streams or image sequences. In some embodiments, frames of video data 116 may be filtered using heuristics-based filtering. In some embodiments, heuristics-based filtering may include filtering using location data

With continued reference to FIG. 1, wherein preprocessing the plurality of frames of video data 116 comprises removing duplicative data 120 from the plurality of frames of video data 116. Duplicative data 120 may include, as a non-limiting example, frames of video data 116 wherein the capturing vehicle is stationary. Therefore, the frames of video data 116 may be substantially similar or duplicative in content. For the purposes of this disclosure, “duplicative data,” is data that is similar to or the same as other data. Duplicative data 120 does not need to be data that is literally duplicative of other data; duplicative data 120 may be data that is similar to (e.g., visually or in terms of content) other data, such that it does not need to be processed along side the other data. As a non-limiting example, this may be useful to reduce the amount of frames of video data 116 that need to be processed, thereby saving processing power. Additionally, this may limit the number of duplicate or similar data entries, making downstream searching more efficient.

With continued reference to FIG. 1, in some embodiments, removing duplicative data 120 may include calculating a location distance metric 124. Calculating a location distance metric 124 may include comparing a first location of a first frame of video data to a second location of a second from of video data. For example, this may include comparing coordinates associated with a first frame of video data to coordinates associated with the second frame of video data.

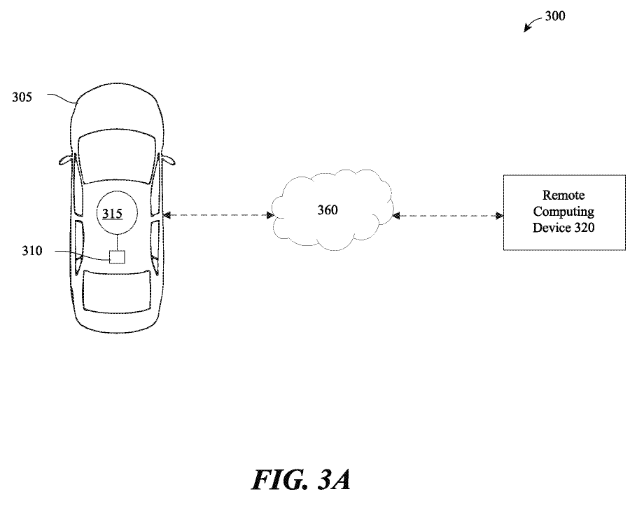

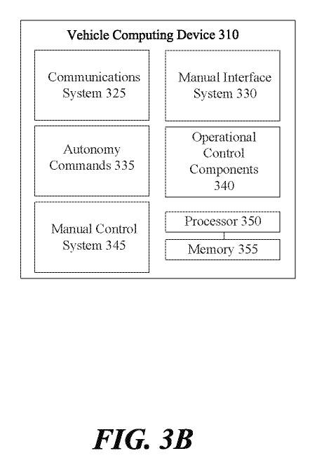

With continued reference to FIG. 1, first location and location data may be retrieved from location data location data 128 of frames of video data 116. As a non-limiting example, location data 128 may include coordinates. In some embodiments, location data 128 may be determined using localization algorithms. Localization algorithms may be run on a vehicle computing device or on a computing device that is remote to the vehicle; this may be further described with respect to FIGS. 3A and 3B. . Localization algorithms may identify a location for a video frame using camera data, LIDAR data, telemetry, microphone data, and/or GPS data. In some embodiments, localization algorithms may be configured to use location data from previously captured frames of video data to for example base a determination of location for the next frame on the determined location of a previous frame. Location distance metric 124 may be a distance between the first location and the second location. As a non-limiting example, location distance metric 124

With continued reference to FIG. 1, memory 112 may include instructions configuring processor 108 to compare location distance metric 124 to a location distance metric threshold 132. Memory 112 may include instructions configuring processor 108 to removing the second frame of video data from the plurality of frames of video data 116 if the location distance metric 124 is below the location distance metric threshold 132.

With continued reference to FIG. 1, filtering of the plurality of frames of video data 116 may include time-frequency sampling of frames from plurality of frames of video data 116. As a non-limiting example, computing device 104 may be configured to select a frame from plurality of frames of video data 116 every second. As a non-limiting example, computing device 104 may be configured to select a frame from plurality of frames of video data 116 every 5 seconds. As a non-limiting example, computing device 104 may be configured to select a frame from plurality of frames of video data 116 every 10 seconds. As a non-limiting example, computing device 104 may be configured to select a frame from plurality of frames of video data 116 every 30 seconds. As a non-limiting example, computing device 104 may be configured to select a frame from plurality of frames of video data 116 every 1 minute. As a non-limiting example, computing device 104 may be configured to select a frame from plurality of frames of video data 116 every 10 minutes. As a non-limiting example, computing device 104 may be configured to select a frame from plurality of frames of video data 116 every 30 minutes. In some embodiments, computing device 104 may be configured to select a frame from plurality of frames of video data 116 every 1 second to 30 minutes. In some embodiments, computing device 104 may be configured to select a frame from plurality of frames of video data 116 every 1 second to 1 minute.

With continued reference to FIG. 1, preprocessing the plurality of frames of video data 116 may include removing video frames for selected time periods. As a non-limiting example, selected time periods may include times when the vehicle is off duty. As a non-limiting example, selected time periods may include times when the vehicle is shut off. As a non-limiting example, memory 112 may include instructions configuring processor 108 to may detect when a vehicle has not moved for an extended period of time and then remove the frames associated with that period of time. In some embodiments, memory 112 may include instructions configuring processor 108 to compare a first frame of video data with a second frame of video data to determine a similarity. This may include for example, calculating a distance metric using image embeddings. In some embodiments, this may include identifying common objects between the frames; as non-limiting examples, cars, pedestrians, or buildings that are common between the frames.

### Generating Natural Language Scene Description

With continued reference to FIG. 1, memory 112 may include instructions configuring processor 108 to generate a natural language scene description 136. In some embodiments, generating natural language scene description 136 may include inputting the preprocessed plurality of frames of video data into a primary large language model (LLM) 140.

With continued reference to FIG. 1, large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, academic report documents, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. For example, LLM may be specifically trained on the ASIC framework as described throughout this disclosure. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “Nice to meet,” then it may be highly likely that the word “you” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It’s also possible that an LLM learns that words structured in this pattern are typically a question and to respond appropriately. In some embodiments, to achieve self-attention, input may be fed into three distinct fully connected neural network layers to create query, key, and value vectors. A query vector may include an entity’s learned representation for comparison to determine attention score. A key vector may include an entity’s learned representation for determining the entity’s relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder’s input to the decoder’s input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with prompts 144 and/or plurality of frames of video data 116.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 1, memory 112 may include instructions configuring processor 108 to receive, as output from primary large language model 140, the natural language scene description 136. For example, primary LLM 140 may generate text that is configured to describe one or more components of plurality of frames of video data 116. As a non-limiting example, natural language scene description 136 may include “a line of cars parked in the right side of the street; a pedestrian crossing the intersection ahead; the street is covered in sunlight.”

With continued reference to FIG. 1, primary LLM 140 may be specifically trained using exemplary frames of video data 116 and exemplary natural language scene descriptions.

With continued reference to FIG. 1, primary LLM 140 may include a multi-modal LLM (MLLM). While traditional LLMs may be configured to process and output textual data, MLLMs may be configured to receive two or more modalities of data as input and generate outputs. In some embodiments, MLLM may be configured to receive textual data, video data, image data, and/or audio data as input. In some embodiments, MLLM may be configured to receive one or more frames of video data 116 and prompt 144. In some embodiments, MLLM may be configured to receive video data and a prompt 144. In some embodiments, MLLM may be configured to receive image data and a prompt 144.

With continued reference to FIG. 1, MLLM may include an image encoder. Image encoder may be configured to convert image data into a numerical representation of the image data. Numerical representation may be referred to as an embedding or feature vector. In some embodiments, image encoder may include a convolutional neural network (CNN). CNN may include a convolutional layer. A convolutional layer is a layer of a neural network that is configured to apply a convolution operation to an input. Convolution operation may include sliding a small window (called a kernel or filter) across the input data and computing the dot product between the values in the kernel and the input at each position. This process may create a feature map that represents detected features in the input.

With continued reference to FIG. 1, CNN may include an activation function. An activation function may calculate an output of a node as a function of a plurality of inputs and associated weights. Activation function may include a Rectified Linear Unit (ReLU) activation function. ReLU activation function may serve to enforce non-linearity for the CNN. In some embodiments, outputs of the convolutional layer may be fed through the activation function.

With continued reference to FIG. 1, CNN may include one or more pooling layers. A pooling layer may be configured to down sample and/or aggregate the spatial dimensions of inputs to retain the most important information. Pooling may include a max pooling layer or an average pooling layer. In some embodiments, CNN may include a convolutional layer and activation function followed by a pooling layer. In some embodiments, CNN may include a convolutional layer and activation function followed by a pooling layer, then followed by another convolutional layer and activation function followed by another pooling layer.

With continued reference to FIG. 1, CNN may include a fully connected layer. A fully connected layer in a neural network is a layer wherein every input neuron is connected to every output neuron. Fully connected layer may be configured to flatten feature maps. In some embodiments, CNN may include a fully connected layer as the final layer before the output is generated.

With continued reference to FIG. 1, image encoder may include a convolutional autoencoder (CAE). In some embodiments, image encoder may include a variational autoencoder (VAE). In some embodiments, image encoder may include a vision transformer (ViT).

With continued reference to FIG. 1, MLLM may include a projection component. Projection component may be configured to project encodings from different modalities into a common embedding space. As a non-limiting example, the encoders of MLLM may generate, for example, textual embeddings and image embeddings. Textual embeddings and image embeddings may then be projected into a common embedding space. As a non-limiting example, the embeddings projected into the common embedding space may be input into the LLM backbone. LLM backbone may be consistent with aspects of the LLM as described in further detail above.

With continued reference to FIG. 1, prompt 144 may be designed to cause primary LLM 140 to generate a natural language scene description 136 that highlights components of frames of video data 116 that are of relevance to an autonomous vehicle. In some embodiments, prompt 144 may be configured to cause primary LLM 140 to output a comprehensive natural language description of the scene’s content and context. Primary LLM 140 may be configured to generate a detailed textual description as natural language scene description 136, capturing salient features and relationships within the scene. In some embodiments, primary LLM 140 may be used to refine the final text. For example, primary LLm 140 may be prompted to remove negative from a final or generated text.

With continued reference to FIG. 1, in some embodiments, memory 112 may include instructions configuring processor 108 to save natural language scene description 136 to a scene search database 148. Scene search database 148 may include a plurality of natural language scene descriptions. Scene search database 148 may be implemented, without limitation, as a relational database, a key-value retrieval database such as a NOSQL database, or any other format or structure for use as a database that a person skilled in the art would recognize as suitable upon review of the entirety of this disclosure. Scene search database 148 may alternatively or additionally be implemented using a distributed data storage protocol and/or data structure, such as a distributed hash table or the like. Scene search database 148 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, memory 112 may include instructions configuring processor 108 to structure natural language scene description 136. Structuring natural language scene description 136 may include extracting one or more keywords from natural language scene description 136 and associating those keywords with natural language scene description 136 for example, in scene search database 148.

### Refining the Natural Language Scene Description

With continued reference to FIG. 1, the natural language scene description 136 generated by primary LLM 140 may be optionally subjected to further processing. In some embodiments, this further processing may include a secondary LLM 152. Memory 112 may include instructions configuring processor 108 to filter the natural language scene description using secondary large language model 152. Secondary LLM 152 may be consistent with LLMs as described further above.

With continued reference to FIG. 1, secondary large language model 152 may be configured to remove language from the natural language scene description 136 indicating object absence to generate filtered natural language scene description 156. Language indicating object absence, as a non-limiting example, may include “no pedestrians are in the cross walk,” “the lane ahead is clear,” “there are no bikes in the bike lane,” or the like. Language indicating object absence is language in natural language scene description 136 that describes objects that are not in the scene of frame of video data 116 rather than the actual contents of frame of video data 116.

With continued reference to FIG. 1, secondary large language model 152 may serve to improve results of search engine 160. As a non-limiting example, a user searching for “pedestrian,” if the language indicating object absence is not removed from natural language scene description 136, search results may include natural language scene descriptions 136 saying, as non-limiting examples, “no pedestrians are in the crosswalk,” or “no pedestrians are crossing the street.” Thus, this language indicating object absence has the capability of spoiling search results. When a use queries search engine 160 for frames including pedestrians, they are given results that include frames with no pedestrians. Therefore, the use of secondary large language model 152 to remove language indicating object absence represents a clear technical improvement to the field of LLM image processing, particularly in image search applications.

With continued reference to FIG. 1, refining natural language scene description 136 may aim to extract specific, structured information from the broad descriptions, thereby enhancing search precision. This may also resolve search ambiguities. For example, if natural language scene description 136 includes a word “tractor trailer” then, after this refinement step, that means that the scene includes a tractor trailer, rather than that indicating that there is “no tractor trailer” in the scene.

With continued reference to FIG. 1, saving natural language scene description to 136 the scene search database 148 may include saving the filtered natural language scene description 156 to the scene search database 148. In some embodiments, wherein a filtered natural language scene description 156 is generated, filtered natural language scene description 156 may be stored in scene search database 148 instead of natural language scene description 136. In some embodiments, a natural language scene description 136 may be generated and stored in scene search database 148, then, once a filtered natural language scene description 156 has been generated, filtered natural language scene description 156 may replace natural language scene description 136 in scene search database 148. In some embodiments, both natural language scene description 136 and filtered natural language scene description 156 may be stored in scene search database 148. In some embodiments, natural language scene description 136 and filtered natural language scene description 156 may be associated together in scene search database 148.

### Search Engine

With continued reference to FIG. 1, memory 112 may include instructions configuring processor 108 to receive, from a user, a user-defined query 164. User-defined query 164 may include a natural language query. As a non-limiting example, natural language query may include “find all of the frames showing the sun.” As a non-limiting example, user-defined query 164 may include a term that the user wishes to search for, e.g., “sun.”

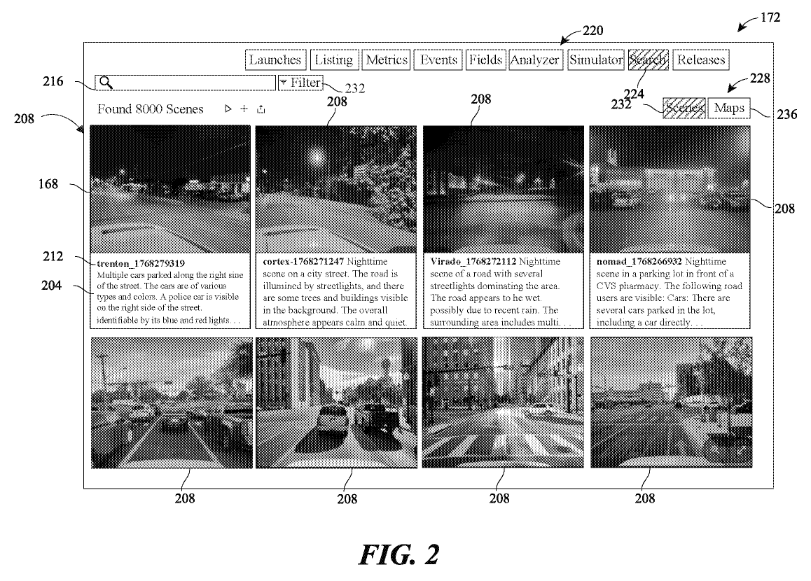

With continued reference to FIG. 1, user-defined query 164 may be received through a user interface. User interface may provide a way for user to interface with a computer, such as computing device 104. In some embodiments, user interface may include a search bar. User may type user-defined query 164 into search bar to initiate a search using search engine 160. User may, as non-limiting examples, click, tap, hit enter, or otherwise provide an input to submit user-defined query 164. User interface, in embodiments, is described further with respect to FIG. 2.

With continued reference to FIG. 1, memory 112 may include instructions configuring processor 108 to return one or more frames of video data 168 selected from the plurality of frames of video data 116 as a function of associated natural language scene descriptions 136 (or 156) for the plurality of frames of video data 116 and the user-defined natural language query 164. In some embodiments, returning one or more frames of video data 168 comprises searching the plurality of frames of video data 116, as a function of the associated natural language scene descriptions 136 (or 156) for the plurality of frames of video data 116 and the user-defined natural language query 164. In some embodiments, this may be done using search engine 160. In some embodiments, search engine 160 may include a dedicated text-based search engine. Text-based search engine may be employed to enable rapid retrieval of scenes based on user-defined natural language queries. In some embodiments, search engine 160 may be configured to perform the search using a look up table, wherein the look up table is populated with natural language scene descriptions 136 (or filtered natural language scene descriptions 156). In some embodiments, search engine 160 may index natural language scene descriptions 136. In some embodiments, search engine 160 may index the filtered natural language scene descriptions 156. In some embodiments, search engine 160 may index both natural language scene descriptions 136 and filtered natural language scene descriptions 156. In some embodiments, search engine 160 may index the contents of scene search database 148. In some embodiments, search engine 160 may be configured to perform precise searches based on both general scene characteristics and specific, extracted information.

### User Interface

With continued reference to FIG. 1, memory 112 may include instructions configuring processor 108 to generating a result user interface 172, wherein the result user interface 172 is configured to visually present the one or more frames of video data 168 to a user. For example, video data 168 may be presented using cards on the result user interface 172.

With continued reference to FIG. 1, memory 112 may include instructions configuring processor 108 to display, through display device 176, result user interface 172 to the user. Display device may include a screen. As non-limiting example, screen may include LCD, OLED, CRT, LED, QLED, Plasma, and the like. Display device may include a monitor, a TV, a smartphone screen, an e reader, an e ink device, a tablet, or the like.

With continued reference to FIG. 1, result user interface 172 may include a visual representation of the one or more frames of video data 168 and the associated natural language scene descriptions 136 or 156 for the one or more of frames of video data 168. In some embodiments, result user interface 172 may include a geographic map display, wherein the geographic map display comprises one or more location indicators, wherein the one or more location indicators are displayed at locations associated with the one or more frames of video data 168. Result user interface 172 is further shown and described with respect to FIG. 2.

Referring now to FIG. 2, an exemplary embodiment of result user interface 172 is shown. Result user interface 172 may include a visual representation of the one or more frames of video data 168 and the associated natural language scene descriptions 204 for the one or more of frames of video data 168. Associated natural language scene descriptions 204 may include, for example, natural language scene descriptions 136 or filtered natural language scene descriptions 156.

With continued reference to FIG. 2, result user interface 172 may include one or more cards 208. A card is a visual component of a user interface that contains a plurality of data. Card 208 may include, as non-limiting examples, a frame of video data 168, an associated natural language scene description 204, and/or a frame identifier 212. A frame identifier 212 is string of number or letters that may be used to identify a frame of video data 168. In some embodiments, frame identifier 212 may include a unique identifier, wherein a unique identifier may uniquely identify a particular frame of video data 168. Frame identifier 212 may include, as a non-limiting example, a city that a frame was captured in. Frame identifier 212 may include, as a non-limiting example, an ID code. As a non-limiting example, frame identifier 212 may include “Trenton_1768279319.”

With continued reference to FIG. 2, one or more cards 208 may be arranged in a grid. Grid may include, as non-limiting examples, a 2 across grid , 3 across grid, 4 across grid, 5 across grid, or 6 across grid. Grid may include 2 rows, 3 rows, 4, rows, and so on. Grid may include as many row as are need to display all of the search results. A user may use a scroll wheel, scroll bar, or touch scrolling to view elements of the grid that are not on the screen yet.

With continued reference to FIG. 2, result user interface 172 may include a search bar 216. Search bar 216 may include a text entry field where user may enter a search term or search phrase. As a non-limiting example, user may enter user-defined query 164 into search bar 216.

With continued reference to FIG. 2, result user interface 172 may include one or more menu buttons 220. One or more menu buttons 220 may include buttons that the user can click on or otherwise interact with or select in order to access elements of the software. In some embodiments, one or more menu buttons 220 may include one or more event handlers. Event handlers are components of software that watch for a action or interaction (i.e. an “event”) and then perform an action as a function of detecting that action or interaction. For example, event handlers may watch for a user to interact with one or more menu buttons 220 and then cause result user interface 172 to update with the requested content. One or more menu buttons 220 may include, as nonlimiting examples, buttons denoted “ Launches,” “Listing,” “Metrics,” “Events,” “Fields,” “Analyzer,” “Simulator,” “Search” 224, or “Releases.” In some embodiments, when a user clicks on search 224, the result user interface 172 may be displayed.

With continued reference to FIG. 2, result user interface 172 may include a display toggle 228. Display toggle 228 may include an event handler configured to watch for a user interacting with display toggle 228 and to update the display accordingly upon detecting the interaction. Display toggle 228 may include a scenes button 232. A user interacting with scenes button 232, may cause result user interface 172 to display the one or more cards 208 as shown in FIG. 2. Display toggle 228 may include a maps button 236. Maps button 236 may cause result user interface 172 to display a map display. Map display may, in some embodiments, include geographic map display, wherein the geographic map display comprises one or more location indicators, wherein the one or more location indicators are displayed at locations associated with the one or more frames of video data. In some embodiments, result user interface 172 may include a filter 232. Filter 232 provides options for a user to filter the search results. Filter 232 may include, as non-limiting example, location filters, temporal filters, content filters, and the like.

### Exemplary Vehicle Computing Architecture

Referring now to FIGS. 3A and 3B, an exemplary vehicle computing architecture 300 is shown. Vehicle computing architecture 300 may include a vehicle 305. A “vehicle,” for the purposes of this disclosure is a device that is designed to transport goods, people, and/or animals. In some embodiments, vehicle 305 may be motorized. As non-limiting examples, vehicle 305 may include a car, a scooter, an ebike, an ATV, a motorcycle, a motorbike, a minibike, a truck, a golf cart, an aircraft, and the like. In some embodiments, vehicle 305 may be human-powered. As non-limiting examples, vehicle 305 may include a bike, a rickshaw, a skateboard, a scooter, or the like.

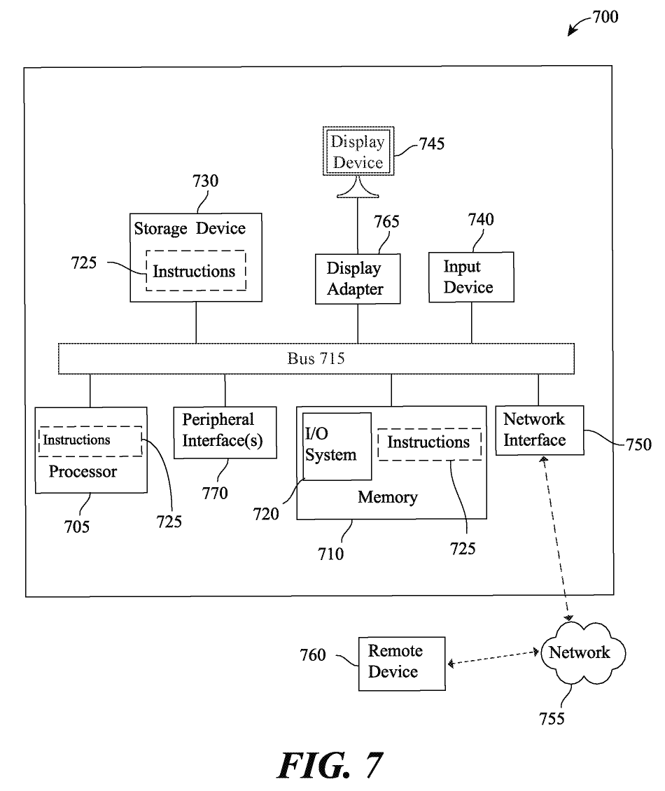

With continued reference to FIGS. 3A AND 3B, the vehicle 305 may be an autonomous vehicle that may drive, navigate, operate, etc. with minimal and/or no interaction from a human driver. Vehicle 305 may include a vehicle computing device 310 that implements a variety of systems on- board the vehicle 305. In some embodiments, vehicle computing device 310 may be consistent with aspects of computing device 700 described further with respect to FIG. 7.

With continued reference to FIGS. 3A and 3B, in some embodiments, vehicle computing architecture 300 may include one or more data acquisition systems 315. A data acquisition systems 315 may include a plurality of sensors configured to detect data from the environment surrounding or inside of vehicle 305. In some embodiments, data acquisition system 315 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 315 may include one or more LIDAR sensors. In some embodiments, data acquisition system 315 may include one or more ultrasound sensors. For example, ultrasound sensors may be mounted around the perimeter of vehicle 305. In some embodiments, ultrasound sensors may be located on the corners of vehicle 305. In some embodiments, ultrasound sensors may be used for object detection and/or collision avoidance. In some embodiments, data acquisition system 315 may include one or more microphones. In some embodiments, microphones may be arranged in an array. In some embodiments, microphones may include directional microphones. In some embodiments, microphones may include unidirectional microphones. In some embodiments data acquisition system 315 may include one or more RADAR sensors. In some embodiments, data acquisition system 315 may include, as non-limiting examples, lane detectors, optical readers, electric eyes, and/or other suitable types of image capture devices.

With continued reference to FIGS. 3A and 3B, vehicle computing device 310 may include a plurality of vehicle computing devices 310. As a non-limiting example, in some embodiments, vehicle computing device 310 may include, a central computing device and one or more auxiliary computing devices. In some embodiments, auxiliary computing devices may be located on or in the vehicle 305 roof. In some embodiments, auxiliary computing devices may be located close to certain sensors of data acquisition system 315 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 3A and 3B, the vehicle 305 may be configured to enter into a ready state. The ready state may indicate that the vehicle 305 is ready to operate (and/or return to) an autonomous navigation mode. A computing device on-board the vehicle 305 may be configured to determine whether the vehicle 305 is in the ready state. A remote computing device 320 (e.g., associated with an operations control center) may indicate that the vehicle 305 is ready to begin and/or resume autonomous navigation.

With continued reference to FIGS. 3A and 3B, for instance, the vehicle computing system 310 may include a communications system 325, one or more manual interface systems 330, one or more data acquisition systems 315, an autonomy command 335, one or more operational control components 340, and/or a manual control system 345.

With continued reference to FIGS. 3A and 3B, the manual interface systems 330 may be configured to allow interaction between a user (e.g., human) and the vehicle 305 (e.g., the vehicle computing system 310). The manual interface systems 330 may include a variety of interfaces for the user to input and/or receive information from the vehicle computing system 310. The manual interface systems 330 may include one or more input device(s) (e.g., touchscreens, keypad, touchpad, knobs, buttons, sliders, switches, mouse, gyroscope, microphone, other hardware interfaces) configured to receive user input. The manual interface systems 330 may include a user interface (e.g., graphical user interface, conversational and/or voice interfaces, chatter robot, gesture interface, other interface types) for receiving user input.

With continued reference to FIGS. 3A and 3B, vehicle computing system 310 may include a processor 350 and a memory 355. Processor 350 and memory 355 may be consistent with other processors and memory described throughout this disclosure. Processor 350 and memory 355 may be communicatively connected. Memory 355 may contain instructions (e.g., software) configured to cause processor 350 to perform one or more actions in accordance with this disclosure.

With continued reference to FIGS. 3A and 3B, vehicle computing architecture 300 may include a remote computing device 320. the remote computing device 320 may include and/or otherwise be associated with one or more computing devices (e.g., computing device 700, referred to in FIG. 7) that are remote from the vehicle 305. The remote computing device 320 may communicate with the vehicle 305 via one or more communications networks 360. The communications network 360 may include various wired and/or wireless communication mechanisms (e.g., cellular, wireless, satellite, microwave, and radio frequency) and/or any desired network topology. For example, the communications network 360 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 305.

### Exemplary Machine-Learning Module and Neural Network

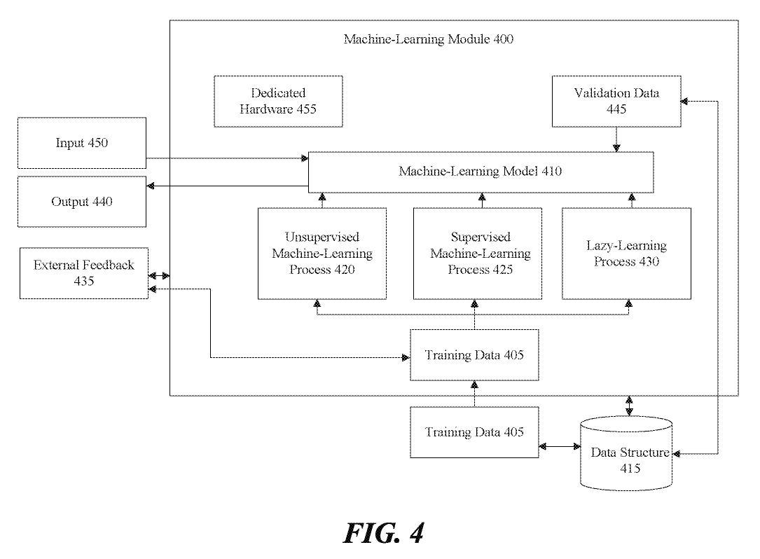

Referring now to FIG. 4, an exemplary embodiment of a machine-learning module 400 is shown. Machine-learning module 400 may be configured to perform one or more machine learning processes as described throughout this disclosure. Machine-learning module 400 may perform determinations, classification, and/or analysis steps, methods, processes, or the like as described in this disclosure using machine learning processes. A “machine learning process,” as used in this disclosure, is a process that automatedly uses training data 405 to generate one or more machine-learning models 410.

With continued reference to FIG. 4, for the purposes of this disclosure, “training data” is data that contains correlations that a machine-learning process may use to model relationships between two or more types of data. For example, training data 405 may include one or more training examples. Multiple data entries in training data 405 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 405 may include input training data correlated to output training data. Input training data may include, as a non-limiting example frames of video data as described further throughout this disclosure. Output training data may include, as a non-limiting example natural language descriptions of the frames of video data, as described further throughout this disclosure. In some embodiments, natural language descriptions of the frames of video data may be tailored to not include language indicating the absence of an object. Elements in training data 405 may be linked to descriptors of categories by tags, tokens, or other data elements; for instance, and without limitation, training data 405 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 4, in some embodiments, training data 405 may be divided into different formats, categories, and/or groups. For example, in some embodiments, training data 405 may be divided into one or more cohorts, categorizations, time periods, data sources, and the like. In some embodiments, training data 405 may be assigned to categories using a classifier; as a non-limiting example, a training data classifier. Training data classifier may include a machine-learning module as described elsewhere with respect to FIG. 4. For example, in some embodiments, training data 405 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 405. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher’s linear discriminant, quadratic classifiers, decision trees, boosted trees, random forest classifiers, learning vector quantization, and/or neural network-based classifiers. In some embodiments, training data 405 may be classified into one or more categories such as locations, times of day, or objects identified in the frame.

With continued reference to FIG. 4, training data 405 may be retrieved, in some embodiments, from a data structure 415. A data structure 415 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 415 may be implemented, without limitation, as a relational database, a key-value retrieval database such as a NOSQL database, or any other format or structure for use as a database that a person skilled in the art would recognize as suitable upon review of the entirety of this disclosure. data structure 415 may alternatively or additionally be implemented using a distributed data storage protocol and/or data structure, such as a distributed hash table or the like. data structure 415 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 415 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 405 may be stored in data structure 415. In some embodiments, training data 405 may be retrieved from data structure 415.

With continued reference to FIG. 4, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 4, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 4, machine-learning process may include an unsupervised machine-learning process 420. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 420 may not require a response variable; unsupervised processes machine-learning process 420 may be used to find interesting patterns and/or inferences between variables, to determine a degree of correlation between two or more variables, or the like.

With continued reference to FIG. 4, machine-learning process may include a supervised machine-learning process 425. Supervised machine-learning process 425 may use training data 405 with both exemplary inputs and expected outputs and use that training data 405 to train a machine-learning model 410. For example, during a training process, machine learning process may evaluate an actual output generated by machine-learning model 410 and compare it to an expected output from training data 405. Based on the difference between the actual and expected outputs, one or more weights within machine-learning model 410 may be updated. For example, in some cases a scoring function may be used to train machine-learning model 410. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 405.

With continued reference to FIG. 4, machine-learning process may include a lazy-learning process 430. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 4, in some embodiments, machine-learning module 400 may receive external feedback 435. External feedback 435 may include, as a non-limiting example, feedback received from a user. In some embodiments, external feedback 435 may be received through a user interface (such as, for example, a graphical user interface (GUI).

With continued reference to FIG. 4, machine-learning module 400 may be configured to re-train machine-learning model 410. In some embodiments, re-training machine-learning model 410 may include re-training machine-learning model 410 as a function of external feedback 435. In some embodiments, external feedback 435 may serve as a source of labeled or partially labeled data that reflects how the model performs in real-world conditions. For example, if a user provides negative external feedback 435, then the set of data from training data 405 may be assigned a negative label. In some embodiments, external feedback 435 may include users correcting an output 440 of machine-learning model 410—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 435, merging it with existing datasets such as training data 405, and/or periodically running a new training cycle to update model parameters.

With continued reference to FIG. 4, machine-learning module 400 may be configured to validate machine-learning model 410. In some embodiments, machine-learning module 400 may validate machine-learning model 410 using validation data 445. Validation data 445 may be a subset of data used to train machine-learning model 405. For example, validation data 445 may include a subset of training data 405. In some embodiments, validation data 445 may include a percentage of training data 405. As non-limiting example, validation data 445 may include 1%,2%, 5%, 10%, 20%, 30%, and the like of training data 405. In some embodiments, machine-learning model 410 may not be exposed to validation data 445 during training. Validation data 445 may acts as a checkpoint that helps determine whether the model is generalizing well or simply memorizing training data 405. As the model learns, its performance on the validation set may be monitored to guide decisions such as choosing hyperparameters, selecting architectures, adjusting regularization strength, or determining when to stop training to avoid overfitting.

With continued reference to FIG. 4, machine-learning model 410 may be configured to receive one or more inputs 450 and generate, as a function of the one or more inputs 450, one or more outputs 440. Outputs 440 may be presented to users for example trough user interfaces and/or GUIs. In some embodiments, external feedback 435 may be received users as a function of output 440.

With continued reference to FIG. 4, one or more, processes, machine-learning processes, actions, steps, or the like as disclosed above may be performed using dedicated hardware 455. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 455 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 455 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 455 to perform one or more operations described herein, such as evaluation of model and/or algorithm outputs, one-time or iterative updates to parameters, coefficients, weights, and/or biases, and/or any other operations such as vector and/or matrix operations as described in this disclosure.

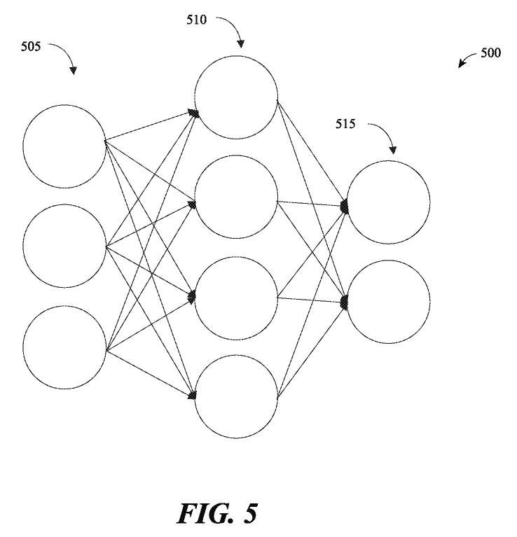

Referring now to FIG. 5, an exemplary embodiment of neural network 500 is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 505, one or more intermediate layers 510, and an output layer of nodes 515. Connections between nodes may be created using a process of "training" the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

### Exemplary Method For Human-Interpretable Autonomous Scene Search

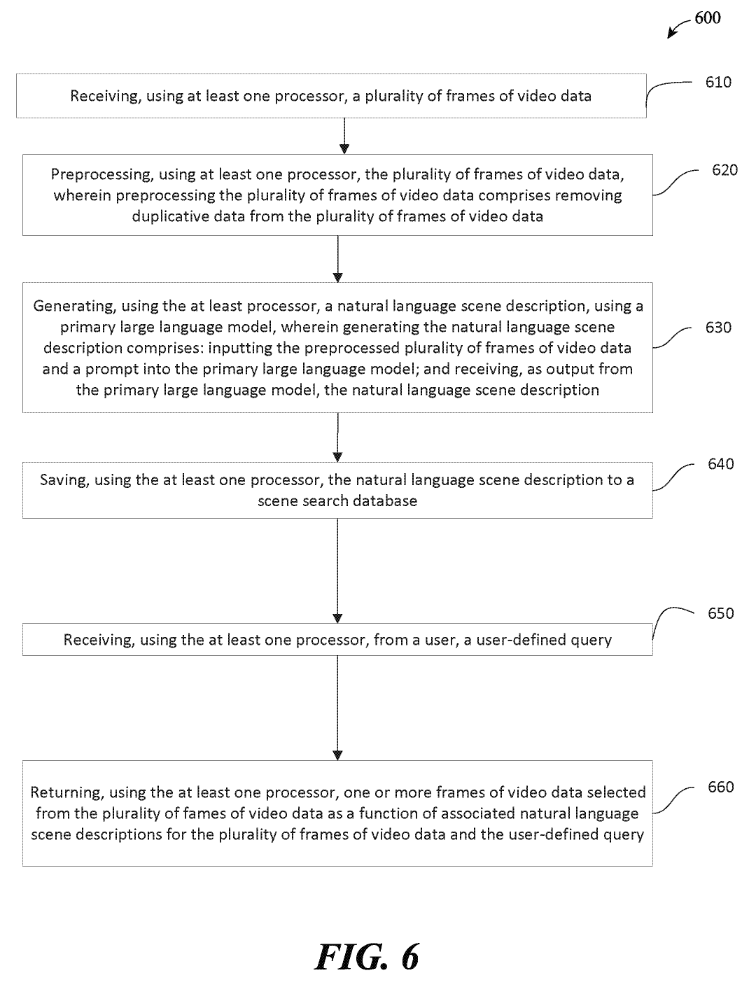

Referring now to FIG. 6, a method 600 for human-interpretable autonomous scene search. Method 600 includes a step 610 of receiving, using at least one processor, a plurality of frames of video data. This may be performed, without limitation, as described with reference to FIGS. 1-5.

Method 600 includes a step 620 of preprocessing, using at least one processor, the plurality of frames of video data, wherein preprocessing the plurality of frames of video data includes removing duplicative data from the plurality of frames of video data. This may be performed, without limitation, as described with reference to FIGS. 1-5.

With continued reference to FIG. 6, method 600 includes a step 630 of generating, using the at least processor, a natural language scene description, using a primary large language model, wherein generating the natural language scene description may include: inputting the preprocessed plurality of frames of video data and a prompt into the primary large language model; and receiving, as output from the primary large language model, the natural language scene description. This may be performed, without limitation, as described with reference to FIGS. 1-5.

With continued reference to FIG. 6, method 600 includes a step 640 of saving, using the at least one processor, the natural language scene description to a scene search database. This may be performed, without limitation, as described with reference to FIGS. 1-5.

With continued reference to FIG. 6, method 600 includes a step 650 of receiving, using the at least one processor, from a user, a user-defined query. This may be performed, without limitation, as described with reference to FIGS. 1-5.

With continued reference to FIG. 6, method 600 includes a step 660 of returning, using the at least one processor, one or more frames of video data selected from the plurality of frames of video data as a function of associated natural language scene descriptions for the plurality of frames of video data and the user-defined query. This may be performed, without limitation, as described with reference to FIGS. 1-5.

In some aspects, the techniques described herein relate to a method, wherein the primary large language model includes a multi-model large language model, wherein the multi-model large language model is configured to receive image data and text data as input.

In some aspects, the techniques described herein relate to a method, further including filtering, using the at least one processor, the natural language scene description using a secondary large language model, wherein the secondary large language model is configured to remove language from the natural language scene description indicating object absence.

In some aspects, the techniques described herein relate to a method, wherein saving the natural language scene description to the scene search database includes saving the filtered natural language scene description to the scene search database.

In some aspects, the techniques described herein relate to a method, wherein returning one or more frames of video data includes searching the plurality of frames of video data, as a function of the associated natural language scene descriptions for the plurality of frames of video data and the user-defined query

In some aspects, the techniques described herein relate to a method, further including structure natural language scene description.

In some aspects, the techniques described herein relate to a method, wherein returning the one or more frames of video data selected from the plurality of frames of video data includes: generating a result user interface, wherein the result user interface is configured to visually present the one or more frames of video data to a user; and displaying, through a display device, the result user interface to the user.

In some aspects, the techniques described herein relate to a method, wherein the result user interface includes a visual representation of the one or more frames of video data and the associated natural language scene descriptions for the one or more of frames of video data.

In some aspects, the techniques described herein relate to a method, wherein the result user interface includes a geographic map display, wherein the geographic map display includes one or more location indicators, wherein the one or more location indicators are displayed at locations associated with the one or more frames of video data.

In some aspects, the techniques described herein relate to a method, wherein removing duplicative data from the plurality of frames of video data includes: calculating a location distance metric including comparing a first location of a first frame of video data to a second location of a second from of video data; comparing the location distance metric to a location distance metric threshold; and removing the second frame of video data from the plurality of frames of video data if the location distance metric is below the location distance metric threshold.

### Exemplary Computer System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 705 and a memory 710 that communicate with each other, and with other components, via a bus 715. Bus 715 may include any of several types of bus structures including, but not limited to, a memory bus, a memory controller, a peripheral bus, a local bus, and any combinations thereof, using any of a variety of bus architectures.

Processor 705 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 705 may be organized according to Von Neumann and/or Harvard architecture as a non-limiting example. Processor 705 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 710 may include various components (e.g., machine-readable media) including, but not limited to, a random-access memory component, a read only component, and any combinations thereof. In one example, a basic input/output system 720 (BIOS), including basic routines that help to transfer information between elements within computer system 700, such as during start-up, may be stored in memory 710. Memory 710 may also include (e.g., stored on one or more machine-readable media) instructions (e.g., software) 725 embodying any one or more of the aspects and/or methodologies of the present disclosure. In another example, memory 710 may further include any number of program modules including, but not limited to, an operating system, one or more application programs, other program modules, program data, and any combinations thereof. Memory 710 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 700 may also include a storage device 730. Examples of a storage device (e.g., storage device 730) include, but are not limited to, a hard disk drive, a magnetic disk drive, an optical disc drive in combination with an optical medium, a solid-state memory device, and any combinations thereof. Storage device 730 may be connected to bus 715 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 730 (or one or more components thereof) may be removably interfaced with computer system 700 (e.g., via an external port connector (not shown)). Particularly, storage device 730 and an associated machine-readable medium may provide nonvolatile and/or volatile storage of machine-readable instructions, data structures, program modules, and/or other data for computer system 700. In some embodiments, storage device 730 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 725) may reside, completely or partially, within machine-readable medium . In another example, software may reside, completely or partially, within processor 705.

Computer system 700 may also include an input device 740. In one example, a user of computer system 700 may enter commands and/or other information into computer system 700 via input device 740. Examples of an input device 740 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 740 may be interfaced to bus 715 via any of a variety of interfaces (not shown) including, but not limited to, a serial interface, a parallel interface, a game port, a USB interface, a FIREWIRE interface, a direct interface to bus 715, and any combinations thereof. Input device 740 may include a touch screen interface that may be a part of or separate from display 745, discussed further below. Input device 740 may be utilized as a user selection device for selecting one or more graphical representations in a graphical interface as described above.

A user may also input commands and/or other information to computer system 700 via storage device 730 (e.g., a removable disk drive, a flash drive, etc.) and/or network interface device 750. A network interface device, such as network interface device 750, may be utilized for connecting computer system 700 to one or more of a variety of networks, such as network 755, and one or more remote devices 760 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data neitwork associated with a telephone/voice provider (e.g., a mobile communications provider data and/or voice network), a direct connection between two computing devices, and any combinations thereof. A network, such as network 755, may employ a wired and/or a wireless mode of communication. In general, any network topology may be used. Information (e.g., data, software, etc.) may be communicated to and/or from computer system 700 via network interface device 750.

Computer system 700 may further include a video display adapter 765 for communicating a displayable image to a display device, such as display 745. Examples of a display device include, but are not limited to, a liquid crystal display (LCD), a cathode ray tube (CRT), a plasma display, a light emitting diode (LED) display, and any combinations thereof. Display adapter 765 and display 745 may be utilized in combination with processor 705 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 715 via a peripheral interface 770. Examples of a peripheral interface include, but are not limited to, a serial port, a USB connection, a FIREWIRE connection, a parallel connection, and any combinations thereof.

Further referring to FIG. 7, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 7, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 7, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 700, processor 705, and memory 710 may be virtualized; that is, a virtual machine and/or container may interact directly with such computing system 700, processor 705, and/or memory 710, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 705 comprises a plurality of processors and/or processor cores, virtualization may, in some cases, simulate or emulate a single (virtual) processor whose functions are allocated to one or more of the plurality of processors and/or processor cores. In this case, while processor 705 may be said to be virtualized, the processor 705, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular systems and methods used to implement the present disclosure may be modified without changing the spirit of the invention, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for human-interpretable autonomous scene search, the system comprising:
at least one processor;
a memory communicatively connected to the at least one processor, wherein the memory contains instructions configuring the at least one processor to:
receive a plurality of frames of video data;
preprocess the plurality of frames of video data, wherein preprocessing the plurality of frames of video data comprises removing duplicative data from the plurality of frames of video data;
generate a natural language scene description, using a primary large language model, wherein generating the natural language scene description comprises:
inputting the preprocessed plurality of frames of video data and a prompt into the primary large language model; and
receiving, as output from the primary large language model, the natural language scene description;
save the natural language scene description to a scene search database;
receive from a user, a user-defined query; and
return one or more frames of video data selected from the plurality of frames of video data as a function of associated natural language scene descriptions for the plurality of frames of video data and the user-defined query.

2. The system of claim 1, wherein the primary large language model comprises a multi-model large language model, wherein the multi-model large language model is configured to receive image data and text data as input.

3. The system of claim 1, wherein the memory contains instructions further configuring the at least one processor to filter the natural language scene description using a secondary large language model, wherein the secondary large language model is configured to remove language from the natural language scene description indicating object absence.

4. The system of claim 3, wherein saving the natural language scene description to the scene search database comprises saving the filtered natural language scene description to the scene search database.

5. The system of claim 1, wherein returning one or more frames of video data comprises searching the plurality of frames of video data, as a function of the associated natural language scene descriptions for the plurality of frames of video data and the user-defined query.

6. The system of claim 1, wherein the memory contains instructions further configuring the at least one processor to structure natural language scene description.

7. The system of claim 1, wherein returning the one or more frames of video data selected from the plurality of frames of video data comprises:
generating a result user interface, wherein the result user interface is configured to visually present the one or more frames of video data to a user; and
displaying, through a display device, the result user interface to the user.

8. The system of claim 7, wherein the result user interface comprises a visual representation of the one or more frames of video data and the associated natural language scene descriptions for the one or more of frames of video data.

9. The system of claim 7, wherein the result user interface comprises a geographic map display, wherein the geographic map display comprises one or more location indicators, wherein the one or more location indicators are displayed at locations associated with the one or more frames of video data.

10. The system of claim 1, wherein removing duplicative data from the plurality of frames of video data comprises:
calculating a location distance metric comprising comparing a first location of a first frame of video data to a second location of a second from of video data;
comparing the location distance metric to a location distance metric threshold; and
removing the second frame of video data from the plurality of frames of video data if the location distance metric is below the location distance metric threshold.

11. A method for human-interpretable autonomous scene search, the method comprising:
receiving, using at least one processor, a plurality of frames of video data;
preprocessing, using the at least one processor, the plurality of frames of video data, wherein preprocessing the plurality of frames of video data comprises removing duplicative data from the plurality of frames of video data;
generating, using the at least processor, a natural language scene description, using a primary large language model, wherein generating the natural language scene description comprises:
inputting the preprocessed plurality of frames of video data and a prompt into the primary large language model; and
receiving, as output from the primary large language model, the natural language scene description;
saving, using the at least one processor, the natural language scene description to a scene search database;
receiving, using the at least one processor, from a user, a user-defined query; and
returning, using the at least one processor, one or more frames of video data selected from the plurality of frames of video data as a function of associated natural language scene descriptions for the plurality of frames of video data and the user-defined query.

12. The method of claim 11, wherein the primary large language model comprises a multi-model large language model, wherein the multi-model large language model is configured to receive image data and text data as input.

13. The method of claim 11, further comprising filtering, using the at least one processor, the natural language scene description using a secondary large language model, wherein the secondary large language model is configured to remove language from the natural language scene description indicating object absence.

14. The method of claim 13, wherein saving the natural language scene description to the scene search database comprises saving the filtered natural language scene description to the scene search database.

15. The method of claim 11, wherein returning one or more frames of video data comprises searching the plurality of frames of video data, as a function of the associated natural language scene descriptions for the plurality of frames of video data and the user-defined query.

16. The method of claim 11, further comprising structure natural language scene description.

17. The method of claim 11, wherein returning the one or more frames of video data selected from the plurality of frames of video data comprises:
generating a result user interface, wherein the result user interface is configured to visually present the one or more frames of video data to a user; and
displaying, through a display device, the result user interface to the user.

18. The method of claim 17, wherein the result user interface comprises a visual representation of the one or more frames of video data and the associated natural language scene descriptions for the one or more of frames of video data.

19. The method of claim 17, wherein the result user interface comprises a geographic map display, wherein the geographic map display comprises one or more location indicators, wherein the one or more location indicators are displayed at locations associated with the one or more frames of video data.

20. The method of claim 11, wherein removing duplicative data from the plurality of frames of video data comprises:
calculating a location distance metric comprising comparing a first location of a first frame of video data to a second location of a second from of video data;
comparing the location distance metric to a location distance metric threshold; and
removing the second frame of video data from the plurality of frames of video data if the location distance metric is below the location distance metric threshold.
